(19) United States
(12) Patent Application Publication
(10) Pub. No.: US 2009/0089975 A1
(43) Pub. Date: Apr. 9, 2009

(54) Hinge Assembly

(76) Inventor: Jr-Jiun Chern, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/869,098

(22) Filed: Oct. 9, 2007

(51) Int. Cl. E05D 11/10

(52) U.S. Cl. 16/321

(57) ABSTRACT

A hinge assembly for use with a notebook computer includes a pintle, a first coupling member, a supporting member, and a biasing device. The first coupling member is pivotally installed on the pintle and includes a connecting portion, a pivotal portion into which the pintle is adapted to insert, a bend extending from the connecting portion, and the bend including an arm formed thereof. The supporting member is pivotally installed on the pintle and includes a hole into which the arm is adapted to insert into. The biasing device is pivotally installed on the pintle and disposed between the pivotal portion and the supporting member, and wherein the biasing device urges the supporting member on the arm.

### BACKGROUND OF THE INVENTION

1. Field of the Invention

The present invention relates to a hinge assembly for use with a notebook computer or the like.

2. Description of the Related Art

Referring to U.S. Pat. No. 7,222,396, a hinge assembly comprises a pivot pin 10, a rotating leaf 20, a stationary leaf 30, and a spacer assembly 40. The spacer assembly 40 includes a L-shaped positioning element 43 which has a tab 431 adapted to insert into the stationary leaf 30. More specifically, the stationary leaf 30 has a hole 32 into which an end portion of the tab 431 insert into. Since the positioning element 43 is stationary and is only connected to the stationary leaf 30 by engagement of the tab 431 with the hole 32. The positioning element 43 often distorts after a period of time, causing an orifice 432 of the positioning element 43 into which the pintle insert become misaligned. In addition, when pivoting the hinge assembly, the rotating leaf 20 and the stationary leaf 30 are often susceptible to distortion by large torque forces.

The present invention is, therefore, intended to obviate or at least alleviate the problems encountered in the prior art.

### SUMMARY OF THE INVENTION

Accordingly, the objective of the present invention is to provide a hinge assembly which overcomes the disadvantages of the prior art.

The hinge assembly includes a pintle, a first coupling member, a supporting member, and a biasing device. The first coupling member is pivotally installed on the pintle and includes a connecting portion, a pivotal portion into which the pintle is adapted to insert, a bend extending from the connecting portion, and the bend including an arm formed thereof The supporting member is pivotally installed on the pintle and includes a hole into which the arm is adapted to insert into. The biasing device is pivotally installed on the pintle and disposed between the pivotal portion and the supporting member, and wherein the biasing device urges the supporting member on the arm.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a hinge assembly in accordance with a first embodiment of the present invention.

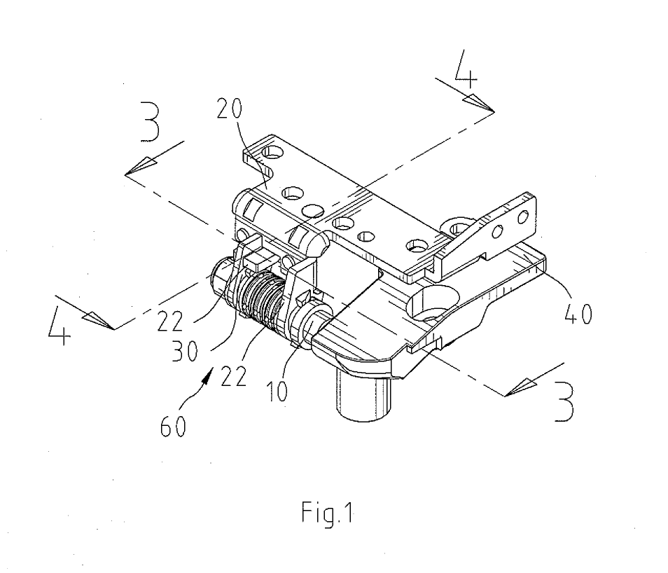

FIG. 2 is an exploded view of the hinge assembly shown in FIG. 1.

FIG. 3 is a cross-sectional view taken along line 3-3 of FIG. 1.

FIG. 4 is a cross-sectional view taken along line 4-4 of FIG. 1.

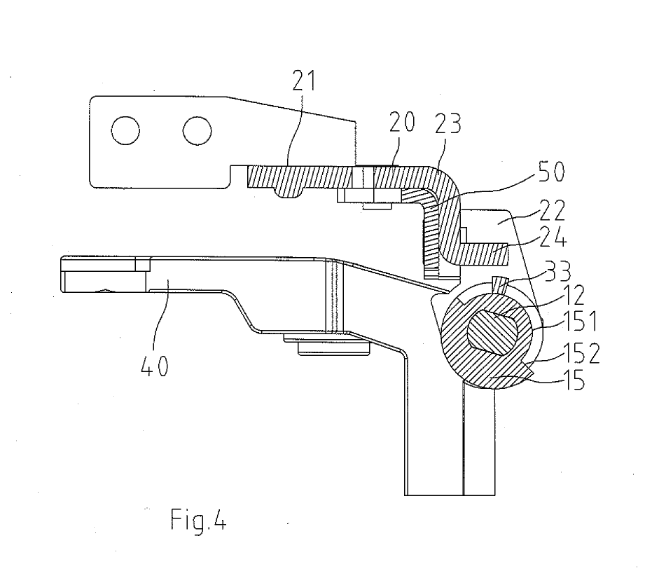

FIG. 5 is similar to FIG. 4, but shows another position of the hinge assembly.

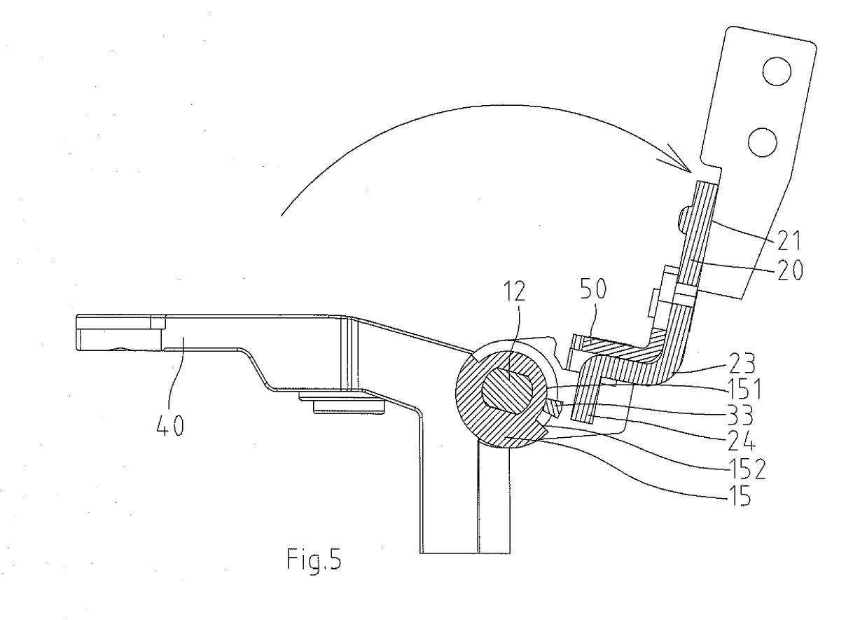

FIG. 6 is a perspective view of a hinge assembly in accordance with a second embodiment of the present invention.

FIG. 7 is an exploded view of the hinge assembly shown in FIG. 6.

### DETAILED DESCRIPTION OF THE PREFERRED EMBODIMENT

Referring to the drawings, a hinge assembly for use with a notebook computer comprises a pintle 10, a first coupling member 20, a supporting member 30, a second coupling member 40, a supporting bracket 50 and a biasing device 60.

The pintle 10 includes a first portion 11 for pivotally engaging with the second coupling member 40, a second portion 12 for pivotally engaging with the first coupling member 20, and a third portion 13 therebetween having a smaller diametrical section 131 and a larger diametrical section 132.

The first coupling member 20 is comprised of a connecting portion 21 to which a display connect. A pivotal portion 22 with which the pintle 10 pivotally engages. In this preferred embodiment, there is mounted a wear-resisting member 14 located against the pivotal portion 22 of the second coupling member 20 and the third portion 13 of the pintle 10. Additionally, the wear-resisting member 14 has two protrusions 141 hooked to the transition area (not numbered) between the smaller and the larger diametrical sections 131, 132. Further, the pivotal portion 22 has a projection 221 formed thereon. When the first coupling member 20 is pivoted with respect to the pintle 10, the protrusion 141 of the wear-resisting member 14 is adapted to stop the projection 221, such that the range in which the projection 221 can move with respect to the wear-resisting member 14 determines range of rotation angles of the notebook.

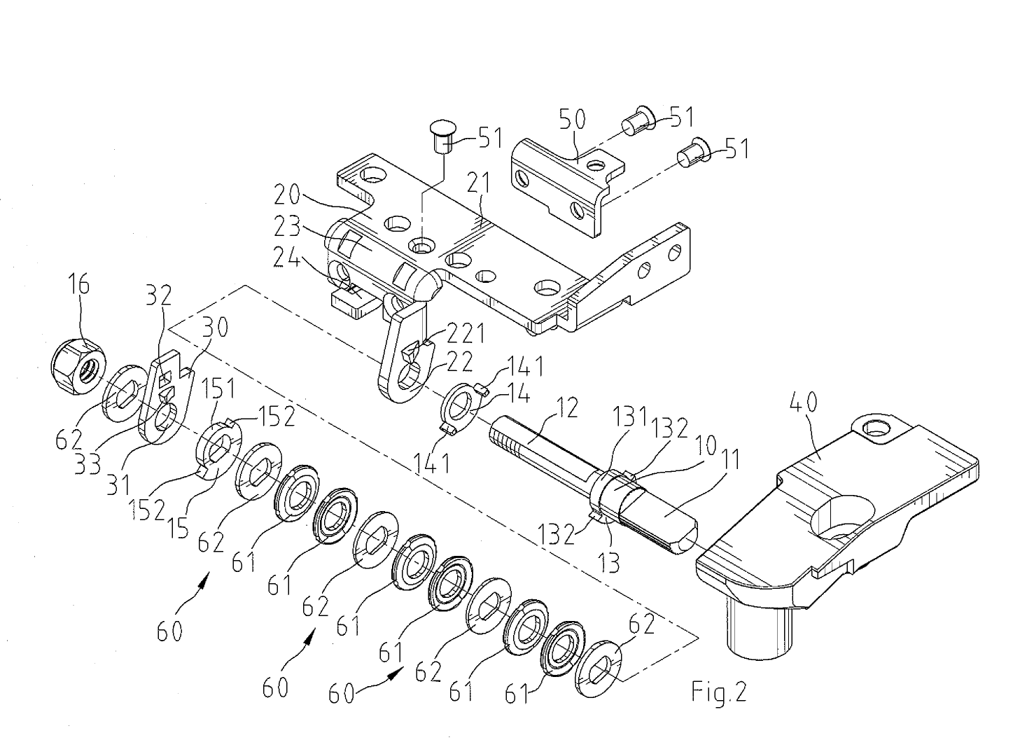

As best shown in FIG. 2, the first coupling member 20 also includes a bend 23 which extends downwardly from the connecting portion 23 such that the bend 23 is substantially perpendicular to the connecting portion 21. Preferably, the pivotal portion 22 of the first coupling member 20 is formed on a side of the bend 23 and is substantially perpendicular thereto.

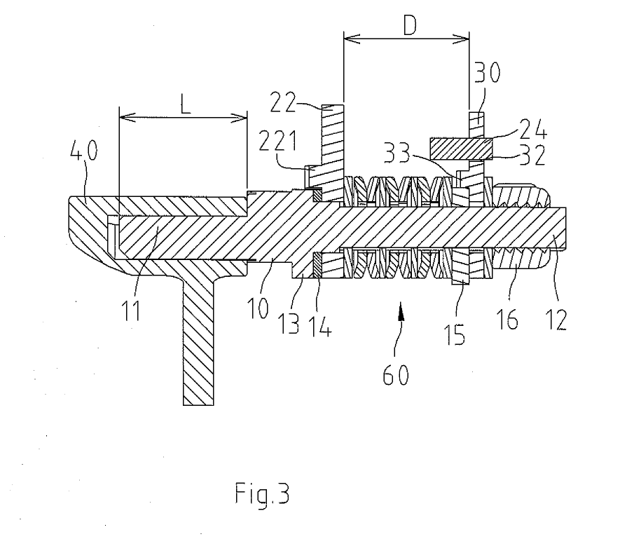

Referring to FIGS. 2 and 3, the bend 23 includes an L-shaped arm 24 extending perpendicular thereto. The arm 24 is adapted to engage with the supporting member 30. More specifically, the arm 24 has a leg (not numbered) adapted to insert into a hole 32 formed thereon. The supporting member 30 has a pivot hole 31 for pivotally engaging with the second portion 12 of the pintle 10. In between the pivotal portion 22 of the first coupling member 20 and the supporting member 30, the biasing device 60 is provided for urging the supporting member 30 on the arm 24. The biasing device 60 is comprised of a plurality of resilient members 61 and spacers 62, with the sequence of one spacer 62, two resilient members 61, and another spacer 62 disposed therebetween. In the preferred embodiment, the hinge assembly further includes a wear-resisting member 15 disposed between the spacer 62 and the supporting member 30. The wear-resisting member 15 defines a smaller diametrical section 151, a larger diametrical section 152, and a transition area therebetween. When the first coupling member 20 is pivoted with respect to the pintle 10, transition area is adapted to stop a projection 33 formed on the supporting member 30 such that the range in which the projection 33 can move with respect to the wear-resisting member 15 determines range of rotation angles of the notebook. Further, the supporting member 30 is retained on the second portion 12 of the pintle 10 by a retainer 16. Preferably, a spacer 62 is provided between the supporting member 30 and the retainer 16.

Fasteners 51 are provided to connect the supporting bracket 50 to the bend 23 of the first coupling member 20 such that the supporting member 50 aids more strength to the first coupling member 20. The supporting bracket 50 is substantially L-shaped.

Referring to FIG. 3, L denotes a length of the first portion 11 of the pintle 10 engaged with the second coupling member 40, and D denotes a distance from a side of the pivotal section 22 and a side of the supporting member 30 in which the biasing device 60 is adapted to abut against the sides. The distance D is equal to the distance L, and since they are equal, the first and second portions 11, 12 of the pintle 10 therefore bear the same torque. Accordingly, the hinge assembly is unlikely to distort after a period of time.

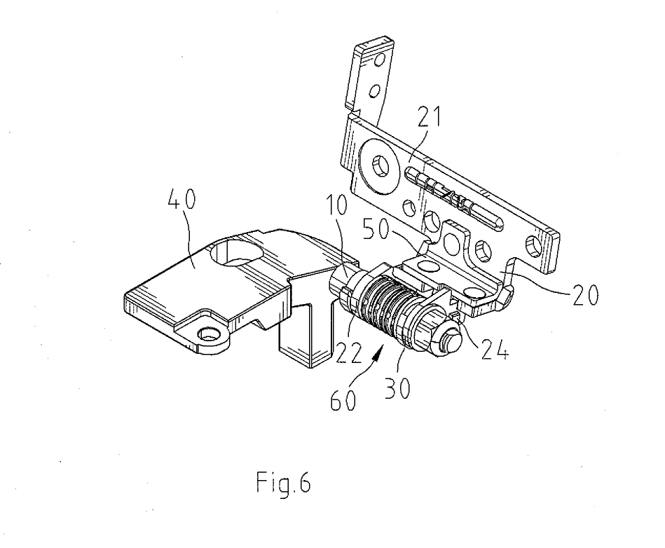

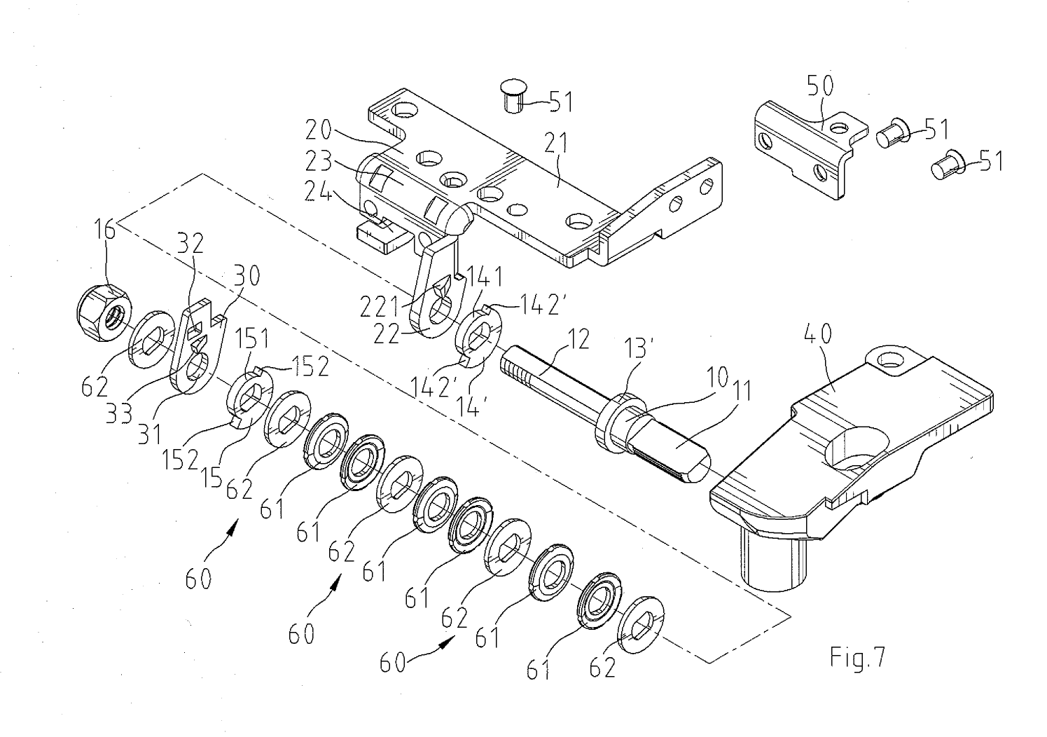

FIGS. 6 and 7 show another hinge assembly embodying the present invention, wherein like numerals are employed to like components of the prior embodiment, like numerals bearing a suffix are employed to indicate the differences. The assembly includes a circular third portion 13′ and a wear-resisting member 14′ configured the same as the wear-resisting member 15.

What is claimed is:

1. A hinge assembly for use with a notebook computer comprising:
a pintle;
a first coupling member pivotally installed on the pintle, the first coupling member including a connecting portion, a pivotal portion into which the pintle is adapted to insert, a bend extending from the connecting portion, and the bend including an arm formed thereof;
a second coupling member pivotally installed on the pintle;
a supporting member pivotally installed on the pintle, the supporting member including a hole into which the arm is adapted to insert into; and
a biasing device pivotally installed on the pintle and disposed between the pivotal portion and the supporting member, and wherein the biasing device urges the supporting member on the arm.

2. The hinge assembly as claimed in claim 1 farther comprises a supporting bracket installed to the bend for strengthening the first coupling member.

3. The hinge assembly as claimed in claim 2 wherein the bend is substantially perpendicular to the connecting portion, and wherein the supporting bracket is substantially L-shaped.

4. The hinge assembly as claimed in claim 1 wherein the pintle has a portion having a length L received in the first coupling member, and wherein the pivotal portion and the supporting member have a separation distance having a length D, and wherein L equals D.

5. The hinge assembly as claimed in claim 1 further comprises a wear-resisting member, and wherein the pintle has a third portion on which the wear-resisting member locate against, and wherein the wear-resisting member is disposed between the third portion and the pivotal portion of the first coupling member.

6. The hinge assembly as claimed in claim 5 wherein the third portion comprises a smaller diametrical section and a larger diametrical section, and wherein the wear-resisting member includes two protrusions hooked to two transition areas between the smaller and larger diametrical sections respectively, and wherein the pivotal portion includes a projection pivotable between the protrusions.

7. The hinge assembly as claimed in claim 6 wherein the third portion is circular, and wherein the wear-resisting member includes a smaller diametrical section and a larger diametrical section.

8. The hinge assembly as claimed in claim 1 further comprises a wear-resisting member disposed between the biasing device and the supporting member.

9. The hinge assembly as claimed in claim 8 wherein the wear-resisting member comprises a smaller diametrical section and a larger diametrical section, and wherein the supporting member includes a projection pivotable between two transition areas between the smaller and larger diametrical sections respectively.

10. The hinge assembly as claimed in claim 1 wherein the biasing device comprises a plurality of resilient members and spacers.

11. The hinge assembly as claimed in claim 1 further comprises a retainer pivotally installed on the pintle, allowing the supporting member to be retained in the pintle.
